(19) United States
(12) Patent Application Publication
(10) Pub. No.: US 2025/0086493 A1
(43) Pub. Date: Mar. 13, 2025

(54) MODEL ASSEMBLY WITH KNOWLEDGE DISTILLATION

(71) Applicant: Cisco Technology, Inc., San Jose, CA (US)

(72) Inventors: Yuguang Yao, Lansing, MI (US); Yuzhang SHANG, Chicago, IL (US); Gaowen LIU, Austin, TX (US); Ramana Rao V. R. KOMPELLA, Foster City, CA (US); Charles FLEMING, Oxford, MS (US)

(21) Appl. No.: 18/243,259

(22) Filed: Sep. 7, 2023

(51) Int. Cl. G06N 20/00

(52) U.S. Cl. CPC G06N 20/00

(57) ABSTRACT

In one implementation, a device receives, via a user interface, one or more constraint parameters for each of a plurality of machine learning models that perform different analytics tasks. The device computes, based on the one or more constraint parameters, a set of weights for the plurality of machine learning models. The device generates a unified model by performing knowledge distillation on the plurality of machine learning models using the set of weights. The device deploys the unified model for execution by a particular node in a network.

### TECHNICAL FIELD

The present disclosure relates generally to computer networks, and, more particularly, to model assembly with knowledge distillation.

### BACKGROUND

With the advents of machine and deep learning, video analytics systems have grown in both their capabilities, as well as their complexities. One use for such systems exists in the context of multi-camera surveillance systems. to detect people and other objects and make decisions about their behaviors. For instance, a surveillance system in an airport or other sensitive area may seek to detect when a person leaves an object unattended.

Machine learning models are often trained with a singular task in mind. For instance, in the case of video analytics, one model may perform object detection, while another model may perform pose estimation. In turn, a video surveillance system may employ both types of models for purposes of assessing the behaviors of people in a crowded area. However, executing multiple models simultaneously can also be resource intensive from both a processing and memory perspective. In some instances, the available resources at the executing device may even be constrained enough that it cannot run all of the models at once. In addition, synchronization is often challenging in video/image processing systems across multiple machine learning models.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example system for performing video analytics;

FIG. 4 illustrates an example of performing model assembly with knowledge distillation;

FIG. 5 illustrates another example of performing model assembly with knowledge distillation;

FIG. 6 illustrates an example user interface for performing model assembly;

FIG. 7 illustrates another example user interface for performing model assembly; and

FIG. 8 illustrates an example simplified procedure for model assembly with knowledge distillation.

### DESCRIPTION OF EXAMPLE IMPLEMENTATIONS

### Overview

According to one or more implementations of the disclosure, a device receives, via a user interface, one or more constraint parameters for each of a plurality of machine learning models that perform different analytics tasks. The device computes, based on the one or more constraint parameters, a set of weights for the plurality of machine learning models. The device generates a unified model by performing knowledge distillation on the plurality of machine learning models using the set of weights. The device deploys the unified model for execution by a particular node in a network.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

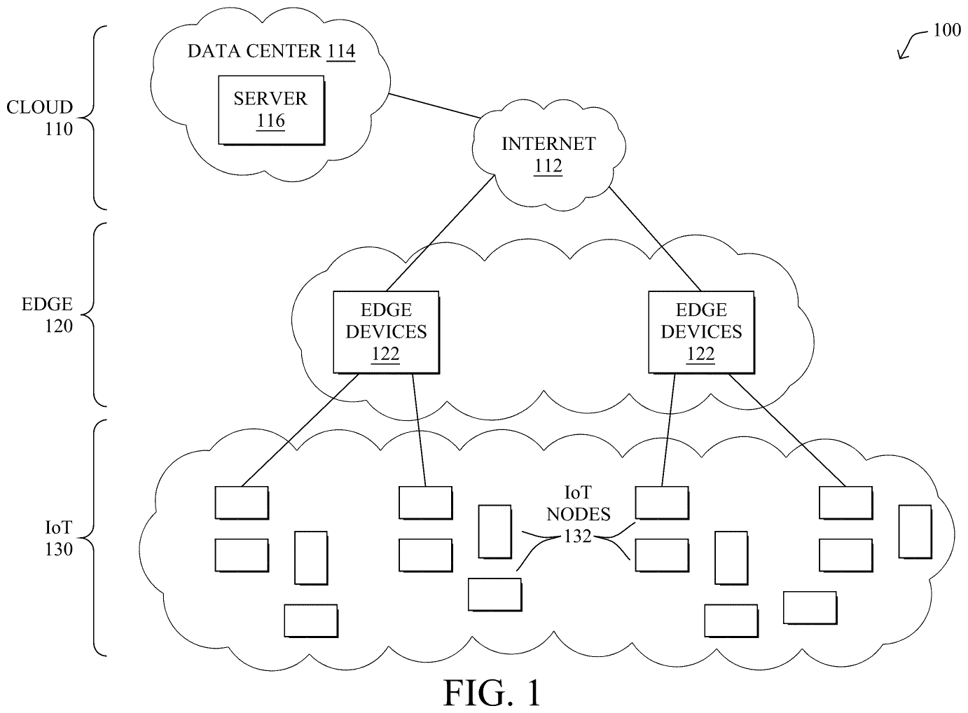

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), or other shared-media protocols where appropriate. In this context, a protocol consists of a set of rules defining how the nodes interact with each other.

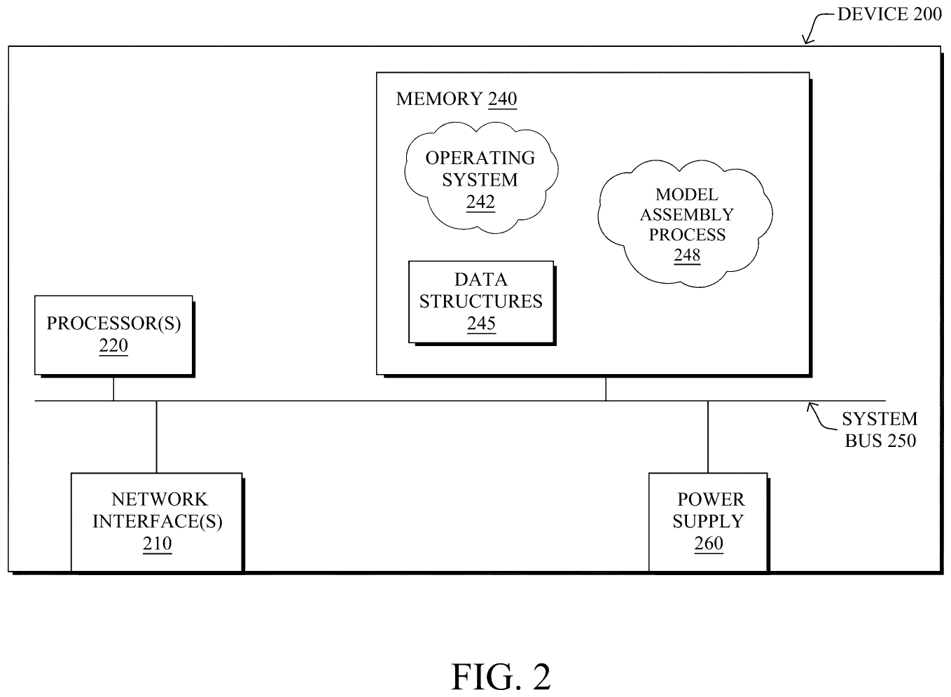

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative model assembly process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, model assembly process 248 may employ one or more supervised, unsupervised, or self-supervised machine learning models. Generally, supervised learning entails the use of a training set of data that is used to train the model to apply labels to the input data. For example, the training data may include sample video data depicting a particular event that has been labeled as such. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Self-supervised learning models take a middle ground approach that uses a greatly reduced set of labeled training data.

Example machine learning techniques that model assembly process process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

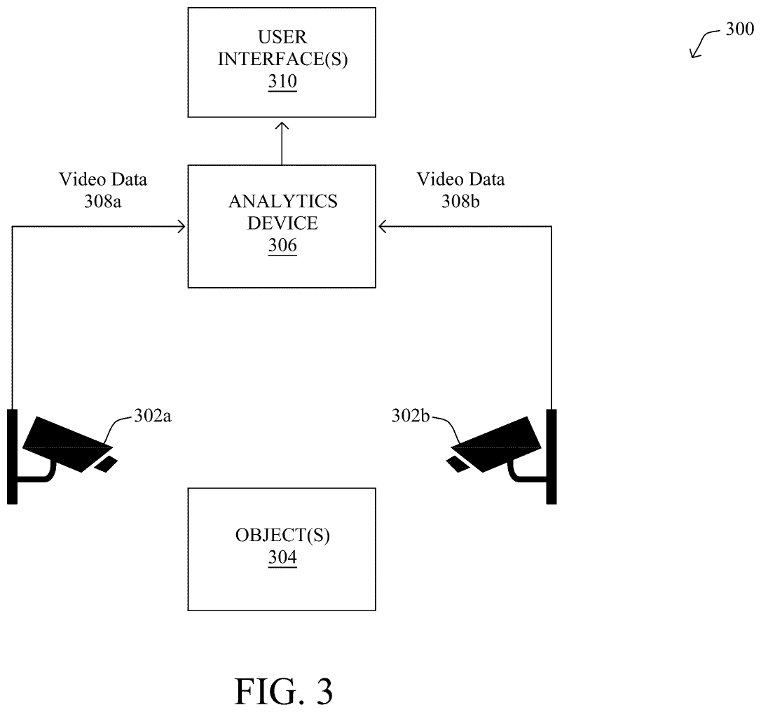

FIG. 3 illustrates an example system 300 for performing video analytics, as described in greater detail above. As shown, there may be any number of cameras 302 deployed to a physical area, such as cameras 302a-302b. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, cameras 302a-302b may generate and send video data 308a-308b, respectively, to an analytics device 306 (e.g., a device 200 executing model assembly process 248 in FIG. 2). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, a particular camera 302, or the lie.

In general, analytics device 306 may be configured to provide video data 308a-308b for display to one or more user interfaces 310, as well as to analyze the video data for events that may be of interest to a potential user. To this end, analytics device 306 may perform object detection on video data 308a-308b, to detect and track any number of objects 304 present in the physical area and depicted in the video data 308a-308b. In some implementations, analytics device 306 may also perform object re-identification on video data 308a-308b, allowing it to recognize an object 304 in video data 308a as being the same object in video data 308b or vice-versa.

As noted above, machine learning models are often trained with a singular task in mind. For instance, in the case of system 300, analytics device 306 may leverage one model to perform object detection on video data 308a-308b and a second model to perform pose estimation on video data 308a-308b. In some cases, analytics device 306 may need to perform both types of analytics tasks for purposes of assessing the behaviors of people in a crowded area.

However, executing multiple models simultaneously can be resource intensive from both a processing and memory perspective. In some instances, the available resources at the executing device, such as analytics device 306, may even be constrained enough that it cannot run all of the models at once. In addition, synchronization is often challenging in video/image processing systems across multiple machine learning models.

### Model Assembly with Knowledge Distillation

The techniques herein allow for the combination of multiple machine learning models into an optimized, unified model. In some aspects, the techniques herein may do so subject to a variety of constraints that an administrator may specify via a user interface, such as the desired accuracy of the unified model, the desired compression ratio, the resources available at the execution device, or the like.

Illustratively, the techniques described herein may be performed by hardware, software, and/or firmware, such as in accordance with the model assembly process 248, which may include computer executable instructions executed by the processor 220 (or independent processor of interfaces 210), to perform functions relating to the techniques described herein.

Specifically, according to various implementations, a device receives, via a user interface, one or more constraint parameters for each of a plurality of machine learning models that perform different analytics tasks. The device computes, based on the one or more constraint parameters, a set of weights for the plurality of machine learning models. The device generates a unified model by performing knowledge distillation on the plurality of machine learning models using the set of weights. The device deploys the unified model for execution by a particular node in a network.

Operationally, in various implementations, one observation herein is that the tasks performed by different machine learning models often have some overlapping aspects, presenting the opportunity to combine models in a more optimized form. More specifically, many of the analytics tasks performed by different machine learning models in a given deployment environment often have some degree of overlap. Rather than executing these models individually at a particular node in a network, the techniques herein propose leveraging knowledge distillation to generate a unified model that is able to perform the various analytics tasks of its teacher models. Because of the overlap of analytics tasks, the unified model will require fewer resources (e.g., in terms of processor and memory) by the execution node.

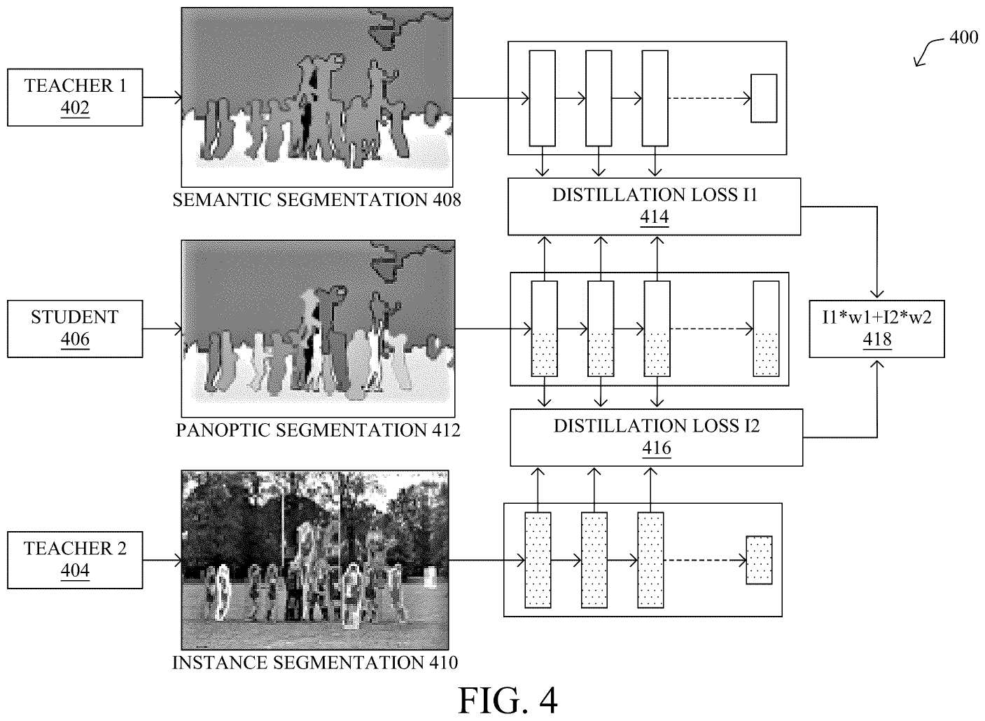

By way of illustration, FIG. 4 illustrates an example 400 of performing model assembly with knowledge distillation, according to various implementations. As shown, assume that there are two existing machine learning models: a teacher model 402 and a teacher model 404. As would be appreciated, in knowledge distillation parlance, the plurality of existing models that are used to train a new model are referred to as ‘teacher’ models, while the resulting model is referred to as a ‘student’ model.

Now, assume that models 402-404 were trained to perform different analytics tasks. For instance, assume that teacher model 402 was trained to perform semantic segmentation 408 on input video data, whereas teacher model 404 was trained to perform instance segmentation 410. Rather than deploy both models to a device for execution, the techniques herein can be used to perform knowledge distillation to generate a student model 406 that is able to perform panoptic segmentation 412 (e.g., a combination of both semantic segmentation 408 and instance segmentation 410).

According to various implementations, the system may use a weighting function 418 that applies weights to the distillation loss 414 associated with teacher model 402 and to distillation loss 416 associated with teacher model 404. These weights can help to control how much each teacher model influences the unified, student model 406. Thus, the resulting model may be more optimized to perform certain analytics tasks over others, depending on the weights computed for the teacher models on which it is trained.

In various implementations, the system may compute the weights for weighting function 418 based on any or all of the following constraint parameters, which an administrator may specify via a user interface or pre-configured for certain deployment environments or use cases:
The desired accuracy for the analytics task of a given teacher model (e.g., detecting a specific type of object, performing a specific type of segmentation, etc.)
The desired compression ratio
Resource constraints of the execution environment
Etc.

Indeed, in practical applications, different deployments may have distinct requirement for different models and/or analytics tasks. This implies that different analytics tasks may necessitate varying levels of accuracy in specific scenarios. For instance, consider the case in which a surveillance system is to monitor traffic at a certain intersection. In such a case, the analytics tasks of identifying vehicles and people may take priority of that of identifying animals (e.g., dogs, cats, etc.). In such a case, the system may adjust the weights for the teacher models that were trained to perform these tasks individually.

For instance, in example 400 shown in FIG. 4, the system may increase the weight for distillation loss 414 associated with teacher model 402, if semantic segmentation 408 needs 90% accuracy and instance segmentation 410 needs only 50% accuracy. In some instances, the computed weights may be proportional to the accuracy and inversely proportional to the compression ratio.

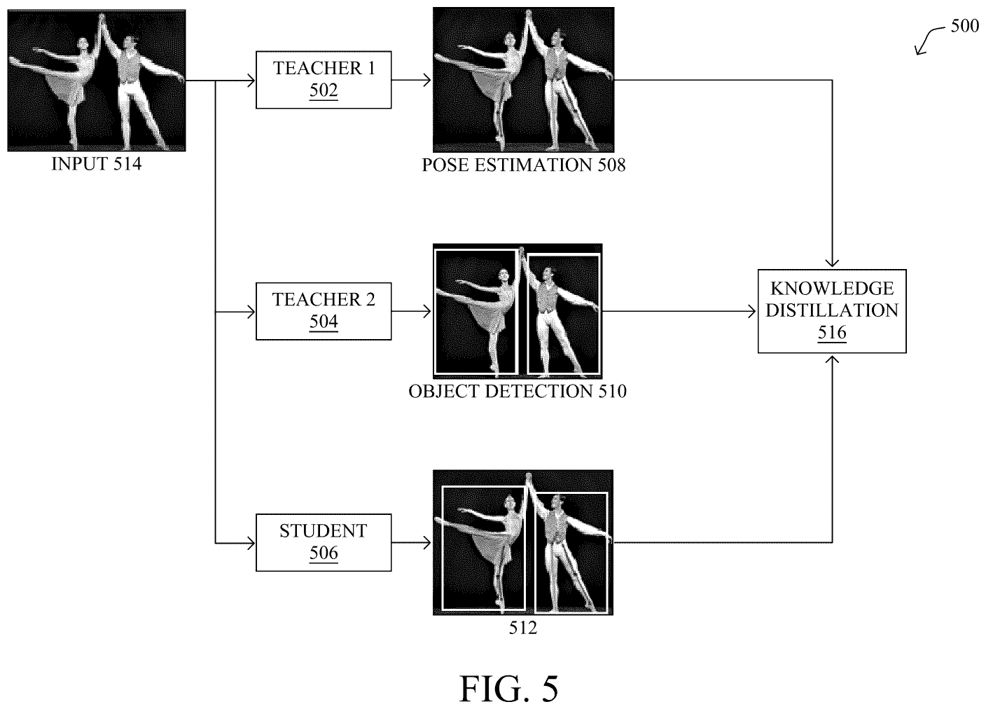

FIG. 5 illustrates another example 500 of performing model assembly with knowledge distillation. As shown, assume now that there are two existing models: a teacher model 502 that was trained to perform pose estimation 508 on input image/video data 514 and a teacher model 504 that was trained to perform object detection 510 on the input image/video data 514.

To reduce the resource requirements to execute both teacher model 502 and teacher model 504, the system may perform knowledge distillation 516 on teacher model 502 and teacher model 504, to produce a student model 506 that is able to perform analytics tasks 512, i.e., both pose estimation 508 and object detection 510.

Similar to the case described in FIG. 4, the weights that the system computes for each of teacher model 502 and teacher model 504 may be based on a set of constraint parameters specified by an administrator, pre-defined, or based on the intended deployment environment or use case.

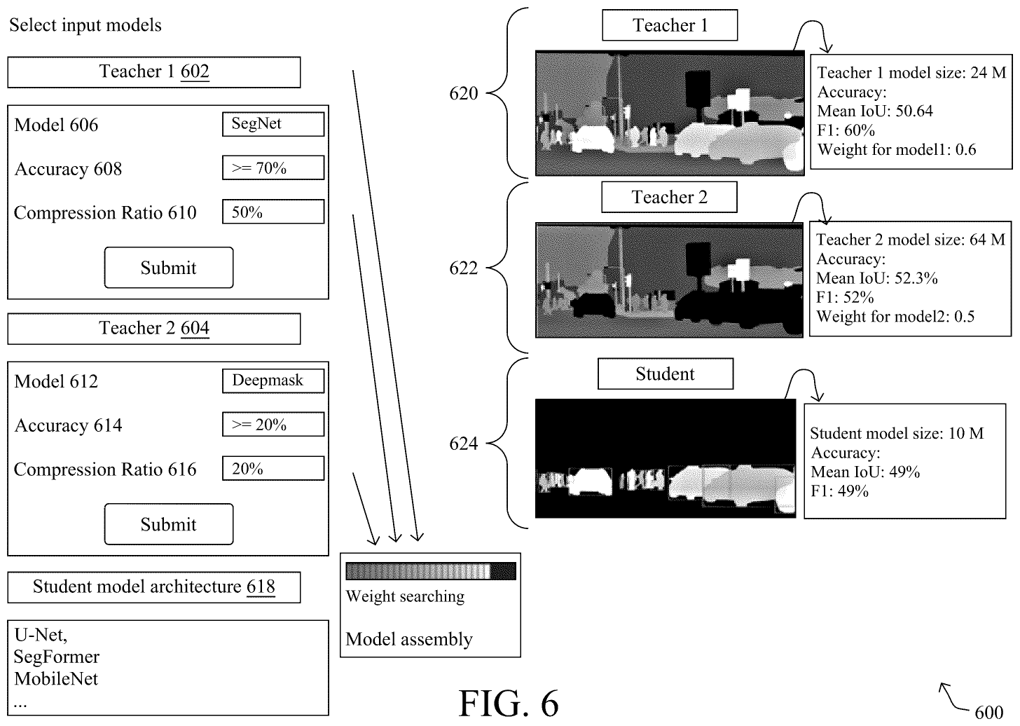

FIG. 6 illustrates an example user interface 600 for performing model assembly, such as the model assembly depicted in FIG. 4. As shown, an administrator may interact with user interface 600 to specify any number of existing teacher models. For instance, the system may maintain a database or library of models that have been trained to perform specific tasks such as various video analytics tasks, anomaly detection, sensor analytics, or the like, and provide information regarding these models via user interface 600 for potential selection.

For each of the selected teacher models, user interface 600 may also allow the administrator to specify any number of constraint parameters for that model. For instance, as shown, assume that the administrator has selected a teacher model 602 and a teacher model 604 to use to train a unified model. In addition, the administrator may also be able to specify via user interface 600 the architecture 618 that the student/unified model is to use, such as U-Net, SegFormer, MobileNet, or the like.

For instance, for model 602, user interface 600 may indicate the model type 606 (e.g., SegNet) of that model and/or other information, such as the analytics task(s) that the model is able to perform. In turn, the administrator may specify constraint parameters such as the desired accuracy 608 (e.g., ≥70%), compression ratio 610 (e.g., 50%), and/or other constraint parameters (e.g., the desired size of the unified model, the resource constraints of the execution device/node, etc.). Similarly, user interface 600 may also display the model type 612 of model 602 and take as input constraint parameters such as a desired accuracy 614 for the analytics task performed by teacher model 604.

One the administrator has submitted their preferences via user interface 600, the system may compute corresponding weights for the specified models. For instance, the system may frame the constraint parameters as a constrained optimization problem or use another suitable optimization approach. In turn, the system uses knowledge distillation to train a student/unified model based on the models specified via user interface 600.

In some implementations, user interface 600 may also provide some information about each of the teacher models and the resulting, unified model. For instance, user interface 600 may display information 620 regarding teacher model 602, such as its model size, accuracy, mean intersection over union (IoU), F1 score, computed weight, or the like. Similarly, user interface 600 may display information 622 regarding teacher model 604, such as its model size, accuracy, mean intersection over union (IoU), F1 score, computed weight, or the like.

In addition, user interface 600 may display information 624 regarding the unified model trained using teacher model 602 and teacher model 604. Here, it can be seen that the unified model has a size of only 10 M, as opposed to teacher model 602, which has a size of 24 M, and teacher model 604, which has a size of 64 M, thus representing a significant resource savings for the executing node.

After reviewing the characteristics of the unified model, the administrator may then operate user interface 600 to either re-train the unified model (e.g., using different constraint parameters) or opt to deploy the unified model. In the latter case, the administrator may select the execution node in the network (e.g., analytics device 306 in FIG. 3) and deploy the unified model for use.

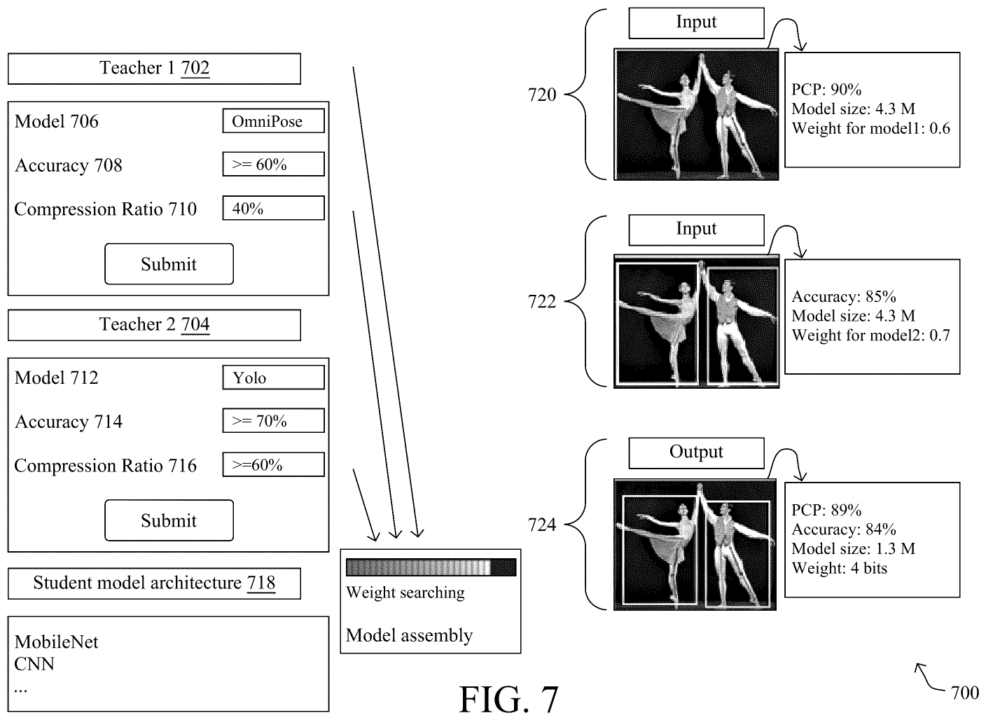

FIG. 7 illustrates another example user interface 700 for performing model assembly, such as to perform the actions depicted in FIG. 5. Similar to FIG. 6, user interface 700 may include various options to allow the administrator to specify any number of teacher models, such as teacher model 702 and teacher model 704, as well as a target architecture 718 for the student model that the system is to generate. For teacher model 702, user interface 700 may display the model type 706 of that model and allow the administrator to specify constraint parameters such as the desired accuracy 708 for the analytics tasks of teacher model 702 exhibited by the unified model, the compression ratio 710, etc. Similarly, for teacher model 704, user interface 700 may display the model type 712 of that model and allow the administrator to specify constraint parameters such as the desired accuracy 714 for the analytics tasks of teacher model 704 exhibited by the unified model, the compression ratio 716, etc.

Once the system has generated the corresponding weights for each of the teacher models specified via user interface 700, it may then present information 720 for teacher model 702, information 722 for teacher model 704, and information 724 for the unified model, thereby allowing the administrator to opt to initiate retraining or deployment of the unified model, as desired.

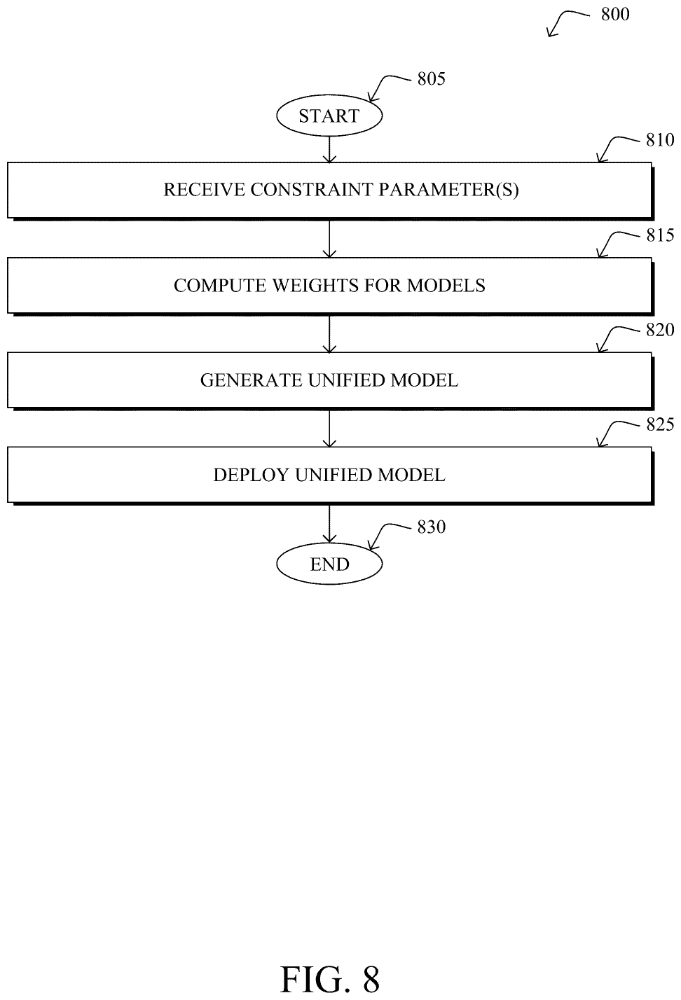

FIG. 8 illustrates an example simplified procedure 800 (e.g., a method) for model assembly with knowledge distillation, in accordance with one or more implementations described herein. For example, a non-generic, specifically configured device (e.g., device 200), such as an edge device, a server, or other device in a network, may perform procedure 800 by executing stored instructions (e.g., model assembly process 248). The procedure 800 may start at step 805, and continues to step 810, where, as described in greater detail above, the device may receive, via a user interface, one or more constraint parameters for each of a plurality of machine learning models that perform different analytics tasks. In some implementations, the different analytics tasks comprise video analytics tasks. For instance, the video analytics tasks may include one or more of: pose estimation, object detection, semantic segmentation, or instance segmentation. In some cases, the one or more constraint parameters comprise a compression ratio. In further cases, the one or more constraint parameters comprise an accuracy threshold. In an additional case, the one or more constraint parameters comprise a resource constraint of the particular node.

At step 815, as detailed above, the device may compute, based on the one or more constraint parameters, a set of weights for the plurality of machine learning models. In various implementations, the set of weights are associated with distillation losses of the plurality of machine learning models during the knowledge distillation to control how much each of the plurality of machine learning models contribute to the unified model.

At step 820, the device may generate a unified model by performing knowledge distillation on the plurality of machine learning models using the set of weights. In various implementations, the unified model performs each of the different analytics tasks of the plurality of machine learning models.

At step 825, as detailed above, the device may deploy the unified model for execution by a particular node in a network. In some cases, the device may also provide, to the user interface, size metrics for the plurality of machine learning models and for the unified model. In an additional instance, the device may also provide, to the user interface, a performance metric for the unified model.

Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for model assembly with knowledge distillation, it is to be understood that various other adaptations and modifications may be made within the spirit and scope of the implementations herein. For example, while certain implementations are described herein with respect to specific use cases for the techniques herein, the techniques can be extended without undue experimentation to other use cases, as well.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
receiving, at a device and via a user interface, one or more constraint parameters for each of a plurality of machine learning models that perform different analytics tasks;
computing, by the device and based on the one or more constraint parameters, a set of weights for the plurality of machine learning models;
generating, by the device, a unified model by performing knowledge distillation on the plurality of machine learning models using the set of weights; and
deploying, by the device, the unified model for execution by a particular node in a network.

2. The method as in claim 1, wherein the unified model performs each of the different analytics tasks of the plurality of machine learning models.

3. The method as in claim 1, wherein the different analytics tasks comprise video analytics tasks.

4. The method as in claim 3, wherein the video analytics tasks comprise one or more of: pose estimation, object detection, semantic segmentation, or instance segmentation.

5. The method as in claim 1, wherein the set of weights are associated with distillation losses of the plurality of machine learning models during the knowledge distillation to control how much each of the plurality of machine learning models contribute to the unified model.

6. The method as in claim 1, wherein the one or more constraint parameters comprise a compression ratio.

7. The method as in claim 1, wherein the one or more constraint parameters comprise an accuracy threshold.

8. The method as in claim 1, wherein the one or more constraint parameters comprise a resource constraint of the particular node.

9. The method as in claim 1, further comprising;
providing, to the user interface, size metrics for the plurality of machine learning models and for the unified model.

10. The method as in claim 1, further comprising:
providing, to the user interface, a performance metric for the unified model.

11. An apparatus, comprising:
a network interface to communicate with a computer network;
a processor coupled to the network interface and configured to execute one or more processes; and
a memory configured to store a process that is executed by the processor, the process when executed configured to:
receive, via a user interface, one or more constraint parameters for each of a plurality of machine learning models that perform different analytics tasks;
compute, based on the one or more constraint parameters, a set of weights for the plurality of machine learning models;
generate a unified model by performing knowledge distillation on the plurality of machine learning models using the set of weights; and
deploy the unified model for execution by a particular node in a network.

12. The apparatus as in claim 11, wherein the unified model performs each of the different analytics tasks of the plurality of machine learning models.

13. The apparatus as in claim 11, wherein the different analytics tasks comprise video analytics tasks.

14. The apparatus as in claim 13, wherein the video analytics tasks comprise one or more of: pose estimation, object detection, semantic segmentation, or instance segmentation.

15. The apparatus as in claim 11, wherein the set of weights are associated with distillation losses of the plurality of machine learning models during the knowledge distillation to control how much each of the plurality of machine learning models contribute to the unified model.

16. The apparatus as in claim 11, wherein the one or more constraint parameters comprise a compression ratio.

17. The apparatus as in claim 11, wherein the one or more constraint parameters comprise an accuracy threshold.

18. The apparatus as in claim 11, wherein the one or more constraint parameters comprise a resource constraint of the particular node.

19. The apparatus as in claim 11, wherein the process when executed is further configured to:
provide, to the user interface, size metrics for the plurality of machine learning models and for the unified model.

20. A tangible, non-transitory, computer-readable medium storing program instructions that cause a device to execute a process comprising:
receiving, at the device and via a user interface, one or more constraint parameters for each of a plurality of machine learning models that perform different analytics tasks;
computing, by the device and based on the one or more constraint parameters, a set of weights for the plurality of machine learning models;
generating, by the device, a unified model by performing knowledge distillation on the plurality of machine learning models using the set of weights; and
deploying, by the device, the unified model for execution by a particular node in a network.
